(19) United States
(12) Patent Application Publication
(10) Pub. No.: US 2015/0160503 A1
(43) Pub. Date: Jun. 11, 2015

(54) LIQUID CRYSTAL DISPLAY AND METHOD OF MANUFACTURING THE SAME

(71) Applicant: Samsung Display Co., Ltd., Yongin-city (KR)

(72) Inventor: Seong-Koo Jeong, Yongin-city (KR)

(73) Assignee: Samsung Display Co., Ltd., Yongin-city (KR)

(21) Appl. No.: 14/259,820

(22) Filed: Apr. 23, 2014

(30) Foreign Application Priority Data
Dec. 6, 2013 (KR) 10-2013-0151713

(51) Int. Cl. G02F 1/1333; G02F 1/1335

(52) U.S. Cl. CPC G02F 1/133308; G02F 1/1336; G02F 2001/133314; G02F 2001/133317; G02F 2001/133325; G02F 2001/133322

(57) ABSTRACT

A liquid crystal display (LCD) and a method of manufacturing the same. The LCD includes an LCD panel, a light unit located below the LCD panel, a first mold frame supporting at least one of the LCD panel and the light unit, a second mold frame disposed to be opposite to the first mold frame and supporting at least one of the LCD panel and the light unit, and a bottom frame. The first mold frame is adjustably installed on the bottom frame, and the second mold frame is fixed to the bottom frame.

### CROSS-REFERENCE TO RELATED APPLICATION

This application claims priority to and the benefit of Korean Patent Application No. 10-2013-0151713, filed on Dec. 6, 2013, which is hereby incorporated by reference for all purposes as if fully set forth herein.

### BACKGROUND

1. Field

Exemplary embodiments of the present invention relate to a liquid crystal display and a method of manufacturing the same.

2. Discussion of the Background

A public information display (PID) is a display for displaying public information using one of a light emitting diode (LED), a liquid crystal display (LCD), and a plasma display panel (PDP). In order to provide a large number of people with information in a public place, a PID displays image information on a plurality of display panels by arranging the display panels in parallel. As a method of allowing consumers to easily access information by easily exposing the information, PIDs receive attention.

An LCD, which is one of the available display panels, has a panel unit, a case protecting the panel unit, and a driving unit. The panel unit has a region on which an image is displayed. However, a non-display region (hereinafter, referred to as a “bezel region”) on which image information is not displayed, is formed on the panel unit by installing the case and the driving unit surrounding a panel.

When arranging more than one panel in parallel, a perception of visual disconnection of displayed images occurs as a result of the presence of the bezel region. Accordingly, it is important to easily transfer information by reducing the bezel region.

The above information disclosed in this Background section is only for enhancement of understanding of the background of the invention and therefore it may contain information that does not constitute prior art.

### SUMMARY

Exemplary embodiments of the present invention include a liquid crystal display, and a method of manufacturing the same.

Additional features of the invention will be set forth in the description which follows and, in part, will be apparent from the description, or may be learned by practice of the invention.

An exemplary embodiment of the present invention discloses a liquid crystal display (LCD) including an LCD panel, a light unit disposed below the LCD panel, a first mold frame supporting at least one of the LCD panel and the light unit, a second mold frame disposed to oppose the first mold frame and to support at least one of the LCD panel and the light unit, and a bottom frame. The first mold frame is adjustably installed on the bottom frame, and the second mold frame is fixed to the bottom frame.

An exemplary embodiment of the present invention also discloses a method of manufacturing an LCD including mounting one end of a light unit on a first mold frame, mounting another end of the light unit on a second mold frame, installing a protection plate on a top of the light unit, and installing an LCD panel by replacing the protection plate. At least one of the installing of the protection plate and the installing the LCD panel includes adjusting a location of the first mold frame and fixing the first mold frame to a bottom frame.

It is to be understood that both the foregoing general description and the following detailed description are exemplary and explanatory, and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a perspective view of a liquid crystal display (LCD) according to an exemplary embodiment of the present invention.

FIG. 2 is a cross-sectional view illustrating a part taken along a line II-II of FIG. 1

FIG. 3 is an exploded perspective view illustrating area “A” of FIG. 2.

FIG. 4 is an inverted cross-sectional view illustrating an example of area “A” of

FIG. 2.

FIG. 5 is an inverted cross-sectional view illustrating another example of area “A” of FIG. 2.

FIGS. 6A, 6B, and 6C are cross-sectional views illustrating a method of manufacturing an LCD according to an exemplary embodiment of the present invention.

FIG. 7 is a cross-sectional view of a commonly-known LCD.

### DETAILED DESCRIPTION OF THE ILLUSTRATED EMBODIMENTS

The present invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. It will be understood that although the terms “first”, “second”, etc. may be used herein to describe various components, these components should not be limited by these terms. These components are only used to distinguish one component from another. Singular expressions, unless defined otherwise in contexts, include plural expressions. In the exemplary embodiments below, it will be further understood that the terms “comprise” and/or “have” used herein specify the presence of stated features or components, but do not preclude the presence or addition of one or more other features or components.

In the drawings, for convenience of description, sizes of elements may be exaggerated or contracted. In other words, since sizes and thicknesses of components in the drawings are arbitrarily illustrated for convenience of explanation, the following exemplary embodiments are not limited thereto.

Like reference numerals designate like elements throughout the specification. It will be understood that when an element is referred to as being “on” or “connected to” another element, it can be directly on or directly connected to the other element, or intervening elements may also be present. In contrast, when an element is referred to as being “directly on” or “directly connected to” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, exemplary embodiments of the present invention will be described in detail with reference to the attached drawings, in which like reference numerals refer to like elements and a repetitive explanation thereof will be omitted.

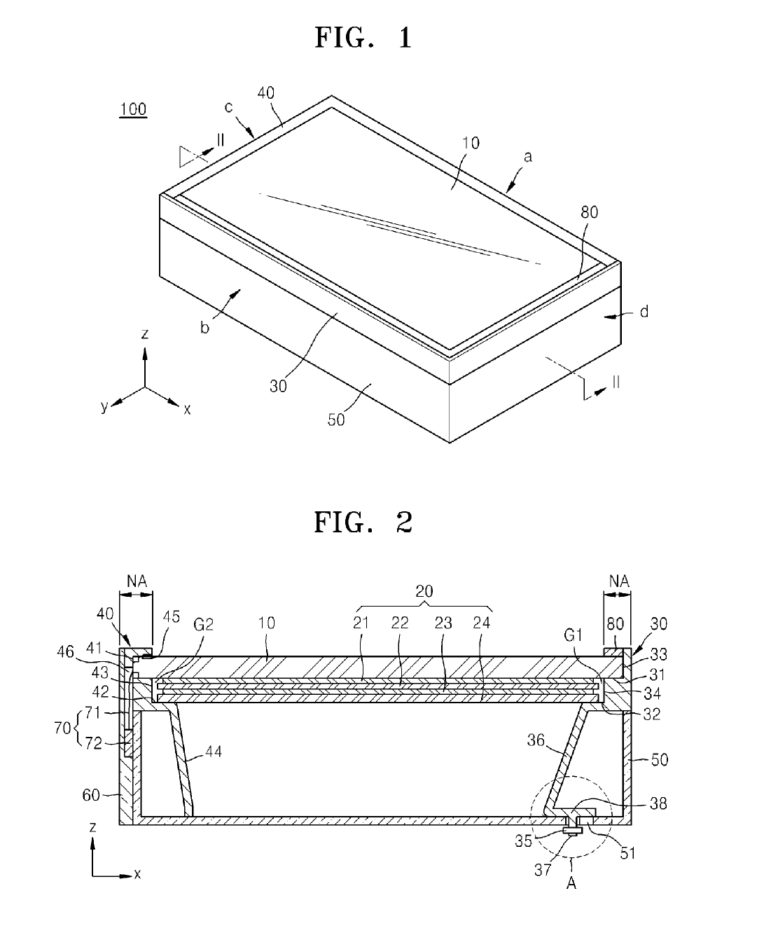

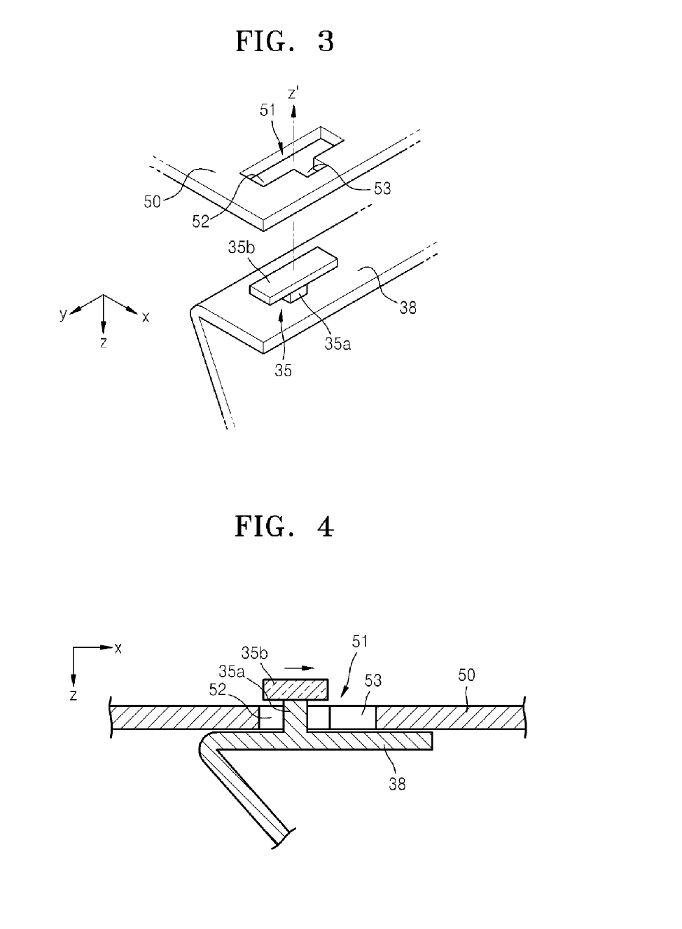

Referring to FIGS. 1 to 3, the LCD 100 may include an LCD panel 10, a light unit 20, a first mold frame 30, a second mold frame 40, a bottom frame 50, a protection cover 60, a driving unit 70, and an adhesive member 80.

The LCD panel 10 receives light from the light unit 20 and displays an image. The LCD panel 10 displays an image on a panel surface by filling a space between two substrates (not shown) with a liquid crystal layer (not shown) and adjusting orientation of the liquid crystals in the liquid crystal layer by applying a driving signal. The LCD panel 10 does not independently emit light, and receives the light from the light unit 20 disposed therebelow in order to display an image in an image display region.

The light unit 20 is disposed on a bottom of the LCD panel 10 to supply the light to a bottom panel surface. The light unit 20 may include a dual brightness enhancement film (DBEF), a prism sheet, a diffuser sheet, and a diffuser plate.

The DBEF 21 is a reflective polaroid film and may increase the brightness of light transmitted to the LCD panel 10. That is, the DBEF 21 repeats a process of allowing some components of incident light to transmit and allows others to be incident after being reflected, thereby reducing a loss of light and increasing brightness.

The prism sheet 22 refracts light emitted from the diffuser sheet 23 disposed below. The prism sheet 22 may increase brightness by concentrating the light emitted from the diffuser sheet 23.

The diffuser sheet 23 may scatter light incident in a certain direction to be uniformly distributed. The diffuser sheet 24 may diffuse light incident from a bottom light source (not shown) to be entirely distributed.

The first mold frame 30 and the second mold frame 40 fix and support the LCD panel 10 and the light unit 20. The first mold frame 30 and the second mold frame 40 are disposed to be opposite to each other.

In the LCD 100, the first mold frame 30 and the second mold frame 40 may be arranged as follows. The LCD panel 10 may be divided into a top side a, which is a long side, a bottom side b opposite to the top side a, a left side c, which is a short side connecting the top side a to the short side b, and a right side d opposite to the left side c. Accordingly, the first mold frame 30 may be formed on one long side of the top side a and the bottom side b, and left and right short sides c and d, respectively. Also, the second mold frame 40, which is disposed opposite to the first mold frame 30, may be formed on another long side of the top side a and the bottom side b and another short side of the left side c and the right side d.

Hereinafter, for convenience for description, there will be described a case in which the first mold frame 30 is formed on the bottom side b and the right side d and the second mold frame 40 is formed on the top side a and the left side c.

The first mold frame 30 is installed on the bottom frame 50 to allow a location thereof to be adjustable in the x direction. The first mold frame 30 may be divided into a first flat portion 31, a second flat portion 32, a first perpendicular portion 33, a second perpendicular portion 34, a projecting portion 35, and a first inclined portion 36. The first flat portion 31 may support the LCD panel 10 by allowing a part of the LCD panel 10 to be mounted thereon. The second flat portion 32 is formed to have a different height from the first flat portion 31 in order to support the light unit 20 by allowing a part of the light unit 20 to be mounted thereon.

The first perpendicular portion 33 is connected to the first flat portion 31 and is formed toward a top of the LCD panel 10. The second perpendicular portion 34 connects the first flat portion 31 to the second flat portion 32 and forms an interval between the light unit 20 and the first mold frame 30. The first inclined portion 36 connects the projecting portion 35 to the first flat portion 31.

The projecting portion 35 may include a first projecting portion 35a projecting from the first mold frame 30 and a second projecting portion 35b perpendicularly connected to the first connecting portion 35a. The second projecting portion 35b is extended in the y direction, which is perpendicular to the moving direction (x direction) of the first mold frame.

More specifically, the first projecting portion 35a is formed on a base portion 38 formed by being bent from the first inclined portion 36, and has a height greater than a thickness of the bottom frame 50. The first projecting portion 35a supports the second projecting portion 35b. The second projecting portion 35b is connected to the first projecting portion 35a, and may be formed while being extended from both ends of a region connected to the first projecting portion 35a. The region formed by being extended to the both ends of the second projecting portion 35b is combined with the bottom frame 50, thereby fastening the first mold frame 30 to the bottom frame 50.

The first mold frame 30 may be fastened to the bottom frame 50 by combining the second projecting portion 35b with a combining member 37. The combining member 37 may combine a plurality of frames and is not limited to a specific member. For example, the combining member 37 may include a rivet, bolt, nut, and screw. Hereinafter, for convenience of description, the combining member 37 includes a screw.

The second mold frame 40 may be fastened to the top of the bottom frame 50. The second mold frame 40 may be divided into an insertion groove 41, a third flat portion 42, a third perpendicular portion 43, and a second inclined portion 44. The insertion groove 41 supports the LCD panel 10 by allowing an end of the LCD panel 10 to be inserted thereinto. The third flat portion 42 is formed below the insertion groove 41 and supports the light unit 20 by allowing the same to be mounted thereon. The third perpendicular portion 43 is connected to the third flat portion 42 and forms a second gap G2 between the light unit 20 and the second mold frame 40. The second inclined portion 44 is extended from the third flat portion 42 and is connected to the frame 50.

A spacer 45 is installed between the insertion groove 41 and the LCD panel 10 and absorbs an external shock transferred through the second mold frame 40. Accordingly, the spacer 45 may prevent different types of defects, such as scratches or flexure, which may be formed on the LCD panel 10.

The bottom frame 50 supports the first mold frame 30 and the second mold frame 40. A light source (not shown) is installed on the bottom surface of the bottom frame 50 to provide the light unit 20 with light.

The bottom frame 50 may include a guide portion 51 in an area A, in which the bottom frame 50 is connected to the first mold frame 30. The projecting portion 35 is inserted into, and guided by, the guide portion 51. The guide portion 51 may include a first opening 52, into which the projecting portion 35 is inserted, and a second opening 53 connected to the first opening 52. The second opening 53 guides the projecting portion 35 while the first mold frame 30 is moved into position.

More specifically, the first opening 52 and the second opening 53 are formed through the bottom of the bottom frame 50. The first opening 52 has a size greater than the second projecting portion 35b to allow the second projecting portion 35b to be inserted into the first opening 52 in the z′ direction (hereinafter, referred to as a “first direction”). The second opening 53 is formed on one side of the first opening to be connected to the first opening 52. When the projecting portion 35 moves in the x direction (hereinafter, referred to as a “second direction”), the first projecting portion 35a may move along the second opening portion 53. Accordingly, the second opening 53 has a width greater than that of the first projecting portion 35a, thereby allowing the first projection portion 35a to move in the second direction. The guide portion 51 has a T shape.

The driving unit 70 applies a driving signal for driving the liquid crystal layer in the LCD panel 10. The driving unit 70 may include a driver integrated circuit (IC) 71 and a printed circuit board (PCB) 72. Because the driver IC 71 and the PCB 72 may have well-known configurations used for LCDs, a detailed description thereof will be omitted.

The PCB 72 may be disposed on an outer surface of the second mold frame 40. In this case, to connect the driver IC 71 and the LCD panel 10 to each other, a second groove 46 may be formed on the second mold frame 40 to allow the driver IC 71 to be disposed therein. Accordingly, the driver IC 71 is installed in the second groove 46 and electrically connects the PCB 72 to the LCD panel 10.

The protection cover 60 may be formed on one of an outer wall of the second mold frame 40 and an outer wall of the bottom frame 50, to protect the outside of the second mold frame 40. The second groove 46 is formed on the outer wall of the second mold frame 40, and the PCB 72 is installed on the outer wall of the bottom frame 50, as described above. As opposed to a surface on which the first mold frame 30 is installed, a surface on which the second mold frame 40 is installed has curved surfaces. Accordingly, in order to hide the curved surfaces and to protect the driver IC 71 and the PCB 72 from external shock, the protection cover 60 is installed.

The adhesive member 80 is installed to attach the first mold frame 30 to the LCD panel 10. The LCD panel 10 is inserted into the insertion groove 41, and the LCD panel 10 mounted on the second mold frame 40 is prevented from being removed upwardly. However, because the LCD panel 10 is mounted on the second flat portion 32 of the first mold frame 30, the LCD panel 10 may be removed upwardly. Accordingly, to prevent a removal of the LCD panel 10 from the first mold frame 30, the first perpendicular portion 33 and the LCD panel 10 are attached to each other using the adhesive member 80. The adhesive member 80 is not limited to a particular material, and may include silicone, synthetic resin, epoxy, etc. For the sake of convenience in the illustrated embodiments, the adhesive member 80 includes silicone.

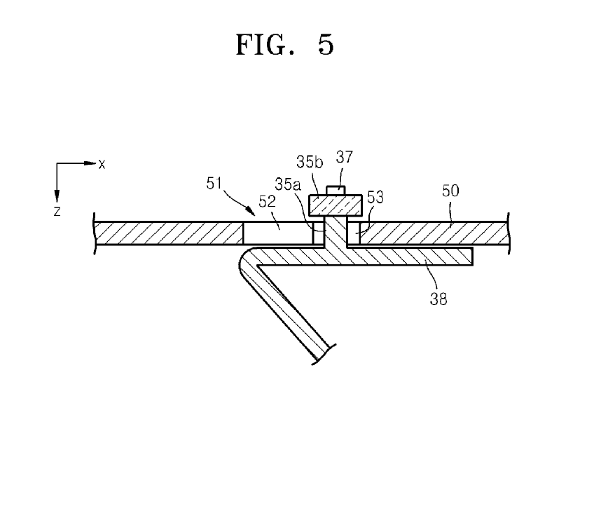

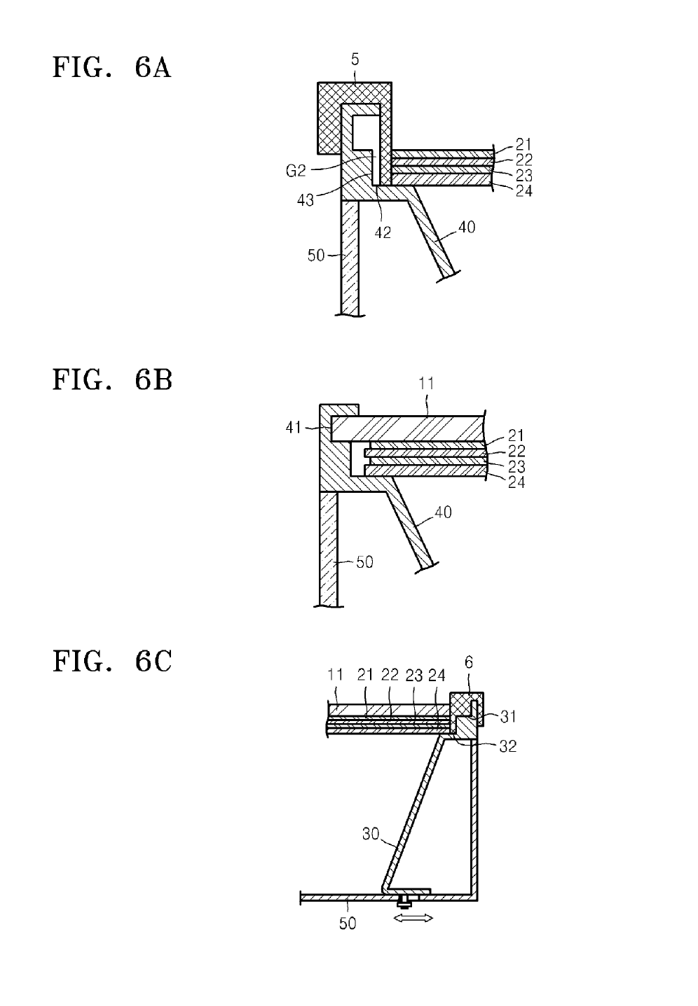

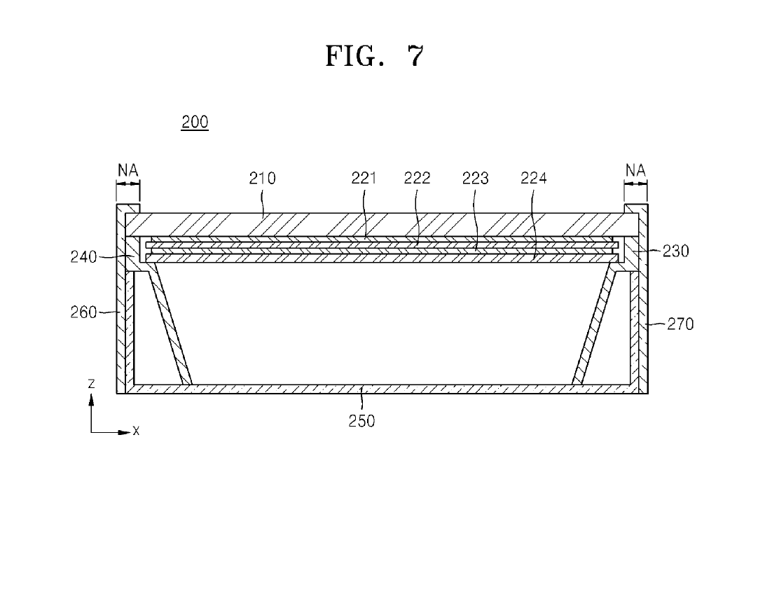

FIGS. 4 and 5 are a cross-sectional view illustrating examples of area “A” of FIG. 2.

Referring to FIGS. 4 and 5, a method of fixing the first mold frame 30 to the bottom frame 50 by adjusting the location of the first mold frame 30 will be described.

The second projecting portion 35b is inserted into the first opening 52 in the first direction, and the second projecting portion 35b then moves in the second direction, thereby inserting the first projecting portion 35a into the second opening 53. In this case, the first projecting portion 35a is also moved in the second direction to allow the first perpendicular portion 33 of the first mold frame 30 and the LCD pane 10 to be closely attached to each other. The combining member 37, for example, a screw, is inserted into a top of the second projecting portion 35b to penetrate the first projecting portion 35a and the first mold frame 30, thereby combining the second projecting portion 35b, the first mold frame 30, and the bottom frame 50 with one another.

The adhesive member 80 is disposed on a top surface of the LCD panel 10 and fixes the first perpendicular portion 33 of the first mold frame 30 and the top surface of the LCD panel 10 to each other. The adhesive member 80 may allow the LCD panel 10 and the first mold frame 30 to be closely attached to each other.

A method of manufacturing the LCD 100 will be described with reference to FIGS. 2, 6A, 6B, and 6C.

A process of the method of manufacturing the LCD 100 may be divided into a process of manufacturing a back light unit (BLU) having a configuration of the LCD 100 excluding the LCD panel 10, and a process of manufacturing a module of mounting the LCD panel 10 on the BLU.

The process of manufacturing the BLU may include mounting the light unit 20 (51) and installing a protection plate 11 (S2).

In operation 51, one end of the light unit 20 is mounted on the second flat portion 32 of the first mold frame 30, as shown in FIG. 6C, and the other end of the light unit 20 is mounted on the third flat portion 42 of the second mold frame 40, as shown in FIG. 6A. Herein, a first jig 5 may be inserted into a space between the third perpendicular portion 43 of the second mold frame 40 and the light unit 20. Accordingly, the second gap G2 between the second mold frame 40 and the light unit 20 may be maintained.

In operation S2, the protection plate 11 is installed on a top of the light unit 20 to protect the light unit 20. One end of the protection plate 11 is inserted into the insertion groove 41 of the second mold frame 40, as shown in FIG. 6B, and another end of the protection plate 11 is mounted on the first flat portion 31 of the first mold frame 30, as shown in FIG. 6C. Herein, a second jig 6 may be inserted into a space among the second perpendicular portion 34 of the first mold frame 30, the light unit 20, and the protection plate 11. Accordingly, a first gap G1 between the first mold frame 30 and the light unit 20 may be maintained, and a removal of the protection plate 11 is prevented. Because the protection plate 11 is replaced by the LCD panel 10, a size of the protection plate 11 may be formed to be identical to the size of the LCD panel 10.

In operation S2, in order to allow the protection plate 11 to be closely attached to the first mold frame 30, the location of the first mold frame 30 may be adjusted and fixed to the bottom frame 50. Because a method of fixing the first mold frame 30 to the bottom frame 50 is similar to a method of adjusting the location of the first mold frame 30 and a method of fixing the first mold frame 30 and the bottom frame 50 to the LCD 100 described above, a description thereof will be omitted.

The process of manufacturing the module includes installing the LCD panel 10

(S3), installing the protection cover 60 (S4), and installing the adhesive member 80 (S5). Because operations S4 and S5 are similar to a description on the configuration of the LCD 100, a description thereto will be only briefly described.

In operation S3, the protection plate 11 is removed from the BLU including the protection plate 11, and the LCD panel 10 is mounted thereon. The combining member 37, that is, a screw combining the second projecting portion 35b with the bottom frame 50 is separated, and the second jig 6 is separated, thereby permitting removal of the protection plate 11 from the BLU.

In order to allow the protection plate 10 to be closely attached to the first mold frame 30, the location of the first mold frame 30 may be adjusted and fixed to the bottom frame 50. Because the method of fixing the first mold frame 30 to the bottom frame 50 is similar to the method of adjusting the location of the first mold frame 30 and the method of fixing the first mold frame 30 and the bottom frame 50 to the LCD 100, the description thereof will be omitted.

In operation S4, the protection cover 60 is installed to protect one of the outside of the second mold frame 40 and the outside of the bottom frame 50. In operation S5, to prevent a removal of the LCD panel 10 from the first mold frame 30, the first perpendicular portion 33 of the first mold frame 30 is combined with the top surface of the LCD panel 10.

Referring to FIG. 7, an LCD 200 typically includes an LCD panel 210, a light unit 220, a first mold frame 230, a second mold frame 240, a bottom frame 250, a first top cover 260, and a second top cover 270. The LCD panel 210 is raised in a bezel portion, which is a non-display region, as a result of the first top cover 260 and the second top cover 270. Also, the bezel portion increases in size resulting from clearances caused by respective components forming the LCD panel 210, or errors in size generated while manufacturing the LCD panel 210.

When LCDs 200 are arranged in parallel to be used as a public information display (PID), a perception of visual disconnections of displayed images occurs resulting from the bezel portions. Accordingly, in order to increase the reliability of people provided with image information by reducing disconnections of displayed images, the size of the bezel portions formed in the LCD 200 of the present invention are minimized.

In case of the LCD 100, because the LCD panel 10 is supported by the first mold frame 30 and the second mold frame 40, a size of the bezel portion formed by the general top covers 260 and 270 may be reduced. Because the location of the first mold frame 30 may be adjusted and fixed to the bottom frame 50, a gap between the first mold frame 30 and the LCD panel 10 is reduced, thereby reducing the size of the bezel portion. In addition, because the gap between the first mold frame 30 and the LCD panel 10 is minimized, gaps among other components of the LCD 100 may be minimized due to the close attachment between the first mold frame and the LCD panel 10 while fixing the first mold frame 30, thereby reducing the size of the bezel portion.

Because an available space for installation is not formed when installing the LCD panel 10 in the LCD 100, there may be concern regarding breakage of the LCD panel 10. In case of the method of manufacturing the LCD 100, the gaps G1 and G2 among the light unit 20, the first mold frame 30, and the second mold frame 40 are regularly formed by using the first jig 5 and the second jig 6, thereby facilitating mounting of the light unit 20.

Because the LCD panel 10 is fixed using the first mold frame 30 and the second mold frame 40 instead of the general top covers 260 and 270, material costs may be reduced.

As described above, according to the exemplary embodiments of the present invention, space availability and manufacturing efficiency are improved.

It should be understood that the exemplary embodiments described therein should be considered in a descriptive sense only and not for purposes of limitation. Descriptions of features or aspects within each embodiment should typically be considered as available for other similar features or aspects in other embodiments.

It will be apparent to those skilled in the art that various modifications and variations can be made in the present invention without departing from the spirit or scope of the invention. Thus, it is intended that the present invention cover the modifications and variations of this invention, provided they come within the scope of the appended claims and their equivalents.

What is claimed is:

1. A liquid crystal display (LCD) comprising:
an LCD panel;
a light unit disposed below the LCD panel;
a first mold frame supporting at least one of the LCD panel and the light unit;
a second mold frame opposing the first mold frame and supporting at least one of the LCD panel and the light unit; and
a bottom frame,
wherein the first mold frame is adjustably disposed on the bottom frame, and the second mold frame is fixed to the bottom frame.

2. The LCD of claim 1, wherein the first mold frame comprises:
a first flat portion supporting the LCD panel;
a second flat portion having a different height from the first flat portion and supporting the light unit;
a first perpendicular portion extending from the first flat portion toward the top of the LCD panel;
a second perpendicular portion connecting the first flat portion to the second flat portion;
a projecting portion combinable with the bottom frame and configured to adjust the location of the first mold frame; and
a first inclined portion connecting the projecting portion to the second flat portion.

3. The LCD of claim 2, wherein the second mold frame comprises:
an insertion groove supporting the LCD panel when an end thereof is inserted thereinto;
a third flat portion supporting the light unit; and
a third perpendicular portion connected to the third flat portion and forming a gap between the light unit and the third perpendicular portion.

4. The LCD of claim 2, wherein the bottom frame comprises a guide portion configured to guide the projecting portion while the projecting portion is moved.

5. The LCD of claim 4, wherein the guide portion comprises:
a first opening, into which the projecting portion is inserted; and
a second opening connected to the first opening and configured to guide the projecting portion while the first mold frame is moved.

6. The LCD of claim 5, wherein when the projecting portion is guided by the second opening, a screw is inserted into the projecting portion to fix the projecting portion, the first mold frame, and the bottom frame with one another.

7. The LCD of claim 1, wherein the first mold frame is movable toward the second mold frame in such a way such that the first mold frame, the second mold frame, and the LCD panel are attached to one another.

8. The LCD of claim 1, further comprising an adhesive member disposed on a top surface of the LCD panel and fixing the first mold frame to the top surface of the LCD panel.

9. The LCD of claim 2, wherein the projecting portion comprises:
a first projecting portion projecting from the first mold frame; and
a second projecting portion extended from the first projecting portion in a direction perpendicular to a moving direction of the first mold frame.

10. The LCD of claim 1, further comprising a protection cover installable on an outer surface of at least one of a portion of an outside of the second mold frame and a portion of an outside of the bottom frame.

11. A method of manufacturing an LCD, comprising:
mounting a first end of a light unit on a first mold frame and a second end of the light unit on a second mold frame;
installing a protection plate on a top of the light unit; and
installing an LCD panel by replacing the protection plate,
wherein at least one of the installing of the protection plate and the installing the LCD panel comprises adjusting a location of the first mold frame and fixing the first mold frame to a bottom frame.

12. The method of claim 11, further comprising installing a protection cover on the outer surface of at least one of the second mold frame and the bottom frame.

13. The method of claim 11, further comprising installing an adhesive member on a top surface of the LCD panel to fix the first mold frame to the top surface of the LCD panel.

14. The method of claim 11, wherein the mounting of the light unit comprises inserting a first jig between the second mold frame and the light unit to maintain a first gap between the second mold frame and the light unit.

15. The method of claim 11, wherein the installing of the protection plate comprises inserting a second jig between the first mold frame and the light unit to maintain a second gap between the first mold frame and the light unit.

16. The method of claim 11, wherein:
the first mold frame comprises a projecting portion; and
the bottom frame comprises a guide portion into which the projecting portion is inserted, for guiding the projecting portion.

17. The method of claim 16, wherein the guide portion comprises:
a first opening, into which the projecting portion is inserted; and
a second opening connected to the first opening for guiding the projecting portion while the first mold frame is moving.

18. The method of claim 17, wherein the projecting portion comprises:
a first projecting portion projecting from the first mold frame; and
a second projecting portion extending from the first projecting portion in a direction perpendicular to a moving direction of the first mold frame.

19. The method of claim 18, wherein the second projecting portion is inserted into the first opening in a first direction, the second projecting portion moves in a second direction perpendicular to the first direction, the first projecting portion is inserted into the second opening, and the second projecting portion is fixed to the bottom frame.
